(19) United States
(12) Patent Application Publication
(10) Pub. No.: US 2010/0075853 A1
(43) Pub. Date: Mar. 25, 2010

(54) HERBICIDALLY ACTIVE COMPOSITION CONTAINING A MONOVALENT SALT OF 4-[2-METHYL-3-(4,5-DIHYDROISOXAZOL-3-YL)-4-METHYLSULFONYLBENZOYL]-1-METHYL-5-HYDROXY-1H-PYRAZOLE

(75) Inventors: Michael Krapp, Altrip (DE); Rainer Berghaus, Speyer (DE); Markus Becker, Meckenheim (DE); Klaus Kolb, Schifferstadt (DE); Bernd Sievernich, Hassloch (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/516,461

(22) PCT Filed: Nov. 9, 2007
(86) PCT No.: PCT/EP07/62125

§ 371 Date: May 27, 2009

(30) Foreign Application Priority Data
Nov. 27, 2006 (EP) 06124814.2

(51) Int. Cl. A01N 43/80; A01P 13/00

(52) U.S. Cl. 504/139; 504/271

(57) ABSTRACT

Herbicidally active composition comprising
a) the compound of the formula I,

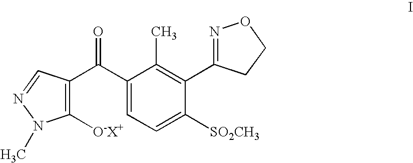

where X is a monovalent cation, and
b) water, where the compound of the formula I is in water-dissolved form.

The present invention relates to a storage-stable, herbicidally active composition which does not form a sediment, which composition comprises a monovalent salt of 4-[2-methyl-3-(4,5-dihydroisoxazol-3-yl)-4-methylsulfonylbenzoyl]-1-methyl-5-hydroxy-1H-pyrazole.

In general, the uniform application of herbicidally active substances, in particular over large areas under cultivation, is a mandatory prerequisite for the effective, environmentally responsible control of weeds. This is ensured for example by using liquid compositions in the spray tank.

3-Heterocyclyl-substituted benzoyl derivatives are known. Representatives of this class of compounds, and their herbicidal activity, are described, for example in WO 96/26206 and WO 98/31681. WO 99/63823 discloses herbicidal mixtures of 4-[2-chloro-3-(4,5-dihydroisoxazol-3-yl)-4-methylsulfonylbenzoyl]-1-methyl-5-hydroxy-1H-pyrazole, nitrogen-comprising fertilizer and an adjuvant.

It was an object of the present invention to find a composition of 4-[2-methyl-3-(4,5-dihydroisoxazol-3-yl)-4-methylsulfonylbenzoyl]-1-methyl-5-hydroxy-1H-pyrazole which is widely applicable. In particular, the composition should have herbicidal activity. In addition, the composition should be storage-stable, should not form a sediment and should be suitable for use for example in the spray tank. A ready-to-use spray mixture is to be prepared from this composition, if appropriate by dilution with water or buffer. The composition is to be used expediently in large containers for efficiently spraying large areas under cultivation. Moreover, the composition is to have a better herbicidal activity, without further additives, than, for example, suspension concentrates of the free active substance.

This object has been achieved with a herbicidally active composition comprising

a) the compound of the formula I,

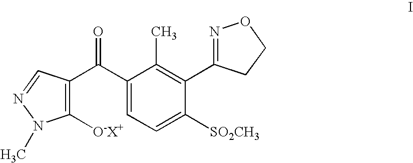

where X is a monovalent cation, and

b) water, where the compound of the formula I is in water-dissolved form.

If appropriate, the user, for example the farmer, will dilute the composition according to the invention with water and/or buffer and, if appropriate, will add further adjuvants or additives, and thus obtain the ready-to-use spray mixture.

The present invention furthermore relates to a method of controlling undesired vegetation, which comprises allowing a composition according to the invention, or a spray mixture comprising it, to act on the plants and/or their environment.

Further embodiments of the present invention can be seen from the claims, the description and the examples. Naturally, the abovementioned features, and the features yet to be illustrated hereinbelow, of the subject matter according to the invention can be used not only in the combination stated, but also in other combinations, without departing from the scope of the invention.

Examples of suitable monovalent cations in the compounds of the formula I are alkali metal or ammonium ions. Thus, the present invention relates to compositions which comprise the compound of the formula I, where X represents alkali metal ions such as Li⁺, Na⁺ or K⁺.

In accordance with one embodiment of the composition, X in the compounds of the formula I is Li⁺.

In accordance with another embodiment of the composition, X in the compounds of the formula I is Na⁺.

In accordance with another embodiment of the composition, X in the compounds of the formula I is K⁺.

The present invention also relates to those compositions which comprise the compound of the formula I with X in the meaning of NR¹R²R³R⁴⁺, where R₁, R₂, R₃, R₄ independently of one another are hydrogen, C₁-C₄-alkyl or 2-(2-hydroxy-eth-1-oxy)-eth-1-yl.

In accordance with one embodiment of the composition, X in the compounds of the formula I is ammonium.

In accordance with another embodiment of the composition, X in the compounds of the formula I is isopropylammonium.

In accordance with another embodiment of the composition, X in the compounds of the formula I is 2-(2-hydroxyeth-1-oxy)eth-1-ylammonium.

Preferred are compositions according to the invention comprising the compound of the formula I in which X is NH₄⁺, Na⁺, K⁺ or Li⁺.

Especially preferred are compositions according to the invention comprising the compound of the formula I in which X is NH₄⁺, Na⁺ or K⁺.

Extraordinarily preferred are compositions according to the invention comprising the compound of the formula I in which X is NH₄⁺ or Na⁺.

Particularly preferred are compositions according to the invention comprising the compound of the formula I in which X is Na⁺.

It is understood that mixtures of compounds of the formula I, which differ from one another by a suitable monovalent cation, can also be used in the composition according to the invention. The number of the different salts and their mixing ratio can be varied.

Usually, the user, for example the farmer, will apply 50 to 500 liters of the ready-to-use spray mixture defined at the outset per hectare of agricultural land, preferably 100 to 400 liters.

The application rate of component a) of the composition according to the invention is usually 2.5 to 100 g/hectare, preferably 5 to 75 g/hectare. Particularly preferred are application rates of from 5 to 25 g/hectare. At a usual spray mixture volume of 50 to 500 liters per hectare, this corresponds to an application concentration of component a) in the range of from 0.005 [g/l_{spray mixture}] to 2 [g/l_{spray mixture}].

In one embodiment, 5 to 50 g/hectare of component a) of the composition according to the invention are used for ‘pre-plant burn-down’, the destruction of undesired vegetation before sowing the crop plants; in a further embodiment for post-emergence application, 5 to 50 g, preferably 5 to 25 g of component a) are present in 50 to 500 liters of spray mixture for an area of one hectare.

The composition according to the invention comprises the compound of the formula I in water, dissolved as component b), in a concentration of from 0.005 [g/l] to 500 [g/l]. In a preferred embodiment, the composition according to the invention comprises the compound of the formula I in water, dissolved as component b), in a concentration of from 1 [g/l] to 400 [g/l]. Especially preferred are concentrations of from 10 [g/l] to 300 [g/l].

The composition according to the invention may comprise the components a) and b) alone. However, it may also comprise one or more further components.

For example, the composition according to the invention may comprise a fertilizer c) in particular a nitrogen-comprising fertilizer.

Examples of nitrogen-comprising fertilizers c) which are suitable are aqueous ammonia solution, ammonium salts, urea and thiourea, and mixtures of these.

Ammonium salts which are suitable as fertilizers are, for example, ammonium nitrate, ammonium sulfate, ammonium hydrogen sulfate, ammonium chloride, ammonium acetate, ammonium formate, ammonium oxalate, ammonium carbonate, ammonium hydrogen carbonate, ammonium nitrate, ammonium thiosulfate, ammonium phosphate, ammonium hydrogen diphosphate, ammonium dihydrogen monophosphate, ammonium sodium hydrogen phosphate, ammonium thiocyanate.

Preferred nitrogen-comprising fertilizers c) are:

urea, ammonium nitrate, ammonium nitrate/urea, ammonium sulfate, ammonium phosphate, ammonium hydrogen diphosphate, ammonium dihydrogen monophosphate and ammonium sodium hydrogen phosphate.

Very especially preferred are:

urea or ammonium nitrate or a mixture of these, for example as a solution. The ammonium nitrate/urea solutions preferably have a total nitrogen content of 27-33% (w/w) and are sold for example by BASF under the Ensol® brand name.

In accordance with one embodiment, the composition according to the invention comprises a nitrogen-comprising fertilizer (component c)) in such an amount that the spray mixture prepared therefrom by the user, for example the farmer, have a final concentration of, for example, urea/ammonium nitrate, of 0.5 to 5% (w/w).

For example, 2.5 l of a 20 to 60% (w/w) strength urea/ammonium-nitrate-comprising solution can be introduced into a metering apparatus in order to prepare 100 l of the ready-to-use spray mixture.

The ready-to-use spray mixture preferably comprises a final concentration of 1.5 to 3.0% (w/w), especially preferably 2.5% (w/w), fertilizer.

In an especially preferred embodiment, the ready-to-use spray mixture comprises, with a customary spray mixture volume of 50 to 500 liters per hectare, 0.5 to 5% (w/w) of component c), and component a) in such an amount that 2.5 to 100 g of the active substance are applied per hectare.

Accordingly, the composition according to the invention, or the ready-to-use spray mixture prepared therefrom, usually comprises the components a) and c) in a ratio of 1:2.5 to 1:10000.

A mixing ratio of components a) and c) of from 1:12.5 to 1:5000 is preferred.

In an especially preferred embodiment, components a) and c) are present in a ratio of from 1:33 to 1:2000 in the ready-to-use spray mixture.

The composition according to the invention may comprise adjuvants as further component d).

Examples of suitable adjuvants d) are vegetable oils which can be partially and fully hydrogenated, modified vegetable oils, mineral oils, alcohol alkoxylates, alcohol ethoxylates, alkylated EO(ethylene oxide)/PO(propylene oxide) block copolymers, alkylphenol ethoxylates, polyols, EO/PO block copolymers, organosilicon compounds, alkylglycosides, alkylpolyglycosides, alkyl sulfates, sulfated alcohol alkoxylates, alkylaryl sulfonates, alkyl sulfonates, dialkylsulfosuccinates, phosphated alcohol alkoxylates, fatty amine alkoxylates, esters, carboxylates, ester ethoxylates, dialkyl adipates, dicarboxylic acid derivatives such as alkenyl succinic anhydride condensates with polyalkylene oxides or with polyhydroxyamines, dialkyl phthalates, ethoxylated sorbitan esters of natural and ethoxylated glycerides of natural fatty acids.

Preferred adjuvants d) are

alcohol alkoxylates such as alkylethers of EO/PO copolymers, for example Plurafac® (BASF AG), Synperionic® LF (ICI), alcohol ethoxylates, the alcohol being a C₈-C₁₈-alcohol of synthetic or natural origin which can be both linear and branched. Depending on the alcohol used, the ethoxylate moiety comprises on average 3-20 mols of ethylene oxide. Examples of products which are used are Lutensol® ON, TO, AO and A from BASF, alkylarylsulfonates such as nonylphenol ethoxylates with 5-15 mols of EO, polyols such as polyethylene glycol or polypropylene glycol, EO/PO block copolymers such as Pluronic® PE (BASF AG) or Synperionic® PE (ICI), organosilicon compounds, alkylpolyglycosides such as Agrimul® (Henkel KGA), AG 6202 (Akzo-Nobel) Atplus® 450 (ICI) or Lutensol® GD 70 (BASF AG), fatty amine alkoxylates such as Ethomeen® and Armobleem® from Akzo Nobel, esters of natural and synthetic fatty acids such as methyl oleates or methyl cocoates, dialkyl adipates, ethoxylated sorbitan esters of natural fatty acids, such as Tween® from ICI Surfactants (Tween® 20, Tweeno 85, Tween® 80), ethoxylated glycerides of natural fatty acids, such as Glycerox® from Croda.

MSO (methylated seed oil) is especially preferably used as component d) in the composition according to the invention.

Further examples can be found in:

McCutcheon's; Emulsifiers and Detergents,

Volume 1: Emulsifiers and Detergents 1994

North American Edition;

McCutcheon's Division, Glen Rock N.J., USA,

McCutcheon's; Emulsifiers and Detergents,

Volume 2: Emulsifiers and Detergents 1994

International Edition;

McCutcheon Division, Glen Rock N.J., USA,

Surfactants in Europe;

A Directory of surface active agents available in Europe

2nd Ed. 1989;

Terg Data, Darlington, UK,

Ash, Michael;

Handbook of cosmetic and personal care additives

1994;

Gower Publishing Ltd, Aldershot, UK

Ash, Michael;

Handbook of industrial Surfactants

1993;

Gower Publishing Ltd. Aldershot, UK.

The composition according to the invention usually comprises the component d) in such an amount that the spray mixture prepared by the user, for example the farmer, has a final concentration of 0.5 to 2.5% (v/v) of adjuvant.

Preferably, the ready-to-use spray mixture comprises a final concentration of 1.0 to 1.5% (v/v), especially preferably 1.25% (v/v) of a suitable adjuvant.

(v/v) is based on the total volume of, for example, the ready-to-use spray mixture.

In an especially preferred embodiment, the ready-to-use spray mixture comprises, with a customary spray mixture volume of 50 to 500 liters per hectare, 1.0 to 1.5% (v/v) of component d), and component a) in such an amount that 2.5 to 100 g of the active substance are applied per hectare.

Accordingly, the composition according to the invention, or the ready-to-use spray mixture, usually comprises, with a spray mixture volume of 50 to 500 liters per hectare the components a) and d) in a ratio (w/w) of 1:2.5 to 1:5000.

A mixing ratio (w/w) of components a) and d) of 1:5 to 1:3000 is preferred.

In an especially preferred embodiment, the components a) and d) are present in a ratio (w/w) of 1:6 to 1:1500 in the ready-to-use spray mixture.

The composition according to the invention can furthermore comprise one or more herbicides (component e)), for example from among the groups E1: acetyl-CoA carboxylase inhibitors (ACC), E2; acetolactate synthase inhibitors (ALS), E3: amides, E4: auxin herbicide, E5: auxin transport inhibitors, E6: carotenoid biosynthesis inhibitors, E7: enolpyruvyl-shikimate 3-phosphate synthase inhibitors (EPSPS), E8: glutamine synthetase inhibitors, E9: lipid biosynthesis inhibitors, E10: mitosis inhibitors, E11: protoporphyrinogen-IX oxidase inhibitors, E12: photosynthesis inhibitors, E13: synergists, E14: growth regulators, E15: cell wall biosynthesis inhibitors, and E16: various other herbicides.

Substances which can be used as component e) are, for example, cyclohexenone oxime ethers or phenoxyphenoxypropionic esters among the group of the acetyl-CoA carboxylase inhibitors (E1, ACC). The acetolactate synthase inhibitors (E2, ALS) include, inter alia, imidazolinones, pyrimidyl ethers, triazolopyrimidines or sulfonylureas. Among the auxin herbicides (E4), pyridine carboxylic acids, 2,4-D or benazoline are relevant, amongst others. Lipid biosynthesis inhibitors (E9) which are used are, inter alia, anilides, chloroacetanilides, thioureas, benfuresate or perfluidone. Suitable as mitosis inhibitors (E10) are, inter alia, carbamates, dinitroanilines, pyridines, butamifos, chlorthal-dimethyl (DCPA) or maleic hydrazide. Examples of protoporphyrinogen-IX oxidase inhibitors (E11) are, inter alia, diphenyl ethers, oxadiazoles, cyclic imides or pyrazoles. Suitable photosynthesis inhibitors (E12) are, inter alia, propanil, pyridate, pyridafol, benzothiadiazinones, dinitrophenols, dipyridylenes, ureas, phenols, chloridazone, triazine, triazinone, uracils or biscarbamates. The synergists (E13) include, inter alb, oxiranes. Growth regulators (E14) are, for example, aryloxyalkanoic acid, benzoic acids or quinoline carboxylic acids. The group “various other herbicides” (E16) is understood as including, inter alia, the active substance classes arylaminopropionic acids, dichloropropionic acids, dihydrobenzofurans, phenyl acetic acids and specific herbicides as mentioned hereinbelow whose mechanism of action is not (precisely) known.

Herbicides e) which can be used in accordance with the present invention are, for example, among others:

E1 acetyl-CoA carboxylase inhibitors (ACC), for example
cyclohexenone oxime ethers, such as alloxydim, clethodim, cloproxydim, cycloxydim, sethoxydim, tralkoxydim, butroxydim, clefoxydim (=profoxydim) or tepraloxydim;
phenoxyphenoxypropionic esters such as clodinafop-propargyl, cyhalofop-butyl, diclofop-methyl, fenoxaprop-ethyl, fenoxaprop-P-ethyl, fenthia-propethyl, fluazifop-butyl, fluazifop-P-butyl, haloxyfop-ethoxyethyl, haloxyfop-methyl, haloxyfop-P-methyl, isoxapyrifop, metamifop, propaquizafop, quizalofop-ethyl, quizalofop-P-ethyl or quizalofop-tefuryl; or
keto-enols such as pinoxaden;

E2 acetolactate synthase inhibitors (ALS), for example
imidazolinones such as imazapyr, imazaquin, imazamethabenzmethyl (imazam), imazamox, imazapic, imazethapyr or imazamethapyr;
pyrimidyl ethers such as pyrithiobac-acid, pyrithiobac-sodium, bispyribac-sodium, pyriminobac-methyl, pyriftalide or pyribenzoxym;
triazolopyrimidines such as florasulam, flumetsulam, metosulam or penoxsulam, diclosulam, cloransulam-methyl;
sulfonylureas such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flucetosulfuron, flupyrsulfuron-methyl-Na, foramsulfuron, halosulfuron-methyl, imazosulfuron, mesosulfuron. metsulfuron-methyl, nicosuifuron, orthosulfamuron, oxasulfuron, primisulfuron-methyl, prosulfuron, pyrazosulfuron-ethyl, rimsulfuron, sulfometuron-methyl, thifensulfuron-methyl, triasulfuron, tribenuron-methyl, triflusulfuron-methyl, trifioxysulfuron, tritosulforon, sulfosulfuron or lodosulfuron;
sulfonylaminocarbonyltriazolinone, such as thienecarbazone, flucarbazone or propoxycarbazone-Na; or
sulfonanilides such as pyrimisulfan;

E3 amides, for example
allidochlor (CDAA), benzoylprop-ethyl, bromobutid, chlorthiamid, diphenamid, etobenzanid (benzchlomet), fluthiamid, fosamin or monalid;

E4 auxin herbicides, for example
pyridine carboxylic acids such as aminopyralid, fluroxypyr, triclopyr, clopyralid or picloram; or
2,4-D or benazoline;

E5 auxin transport inhibitors, for example
naptalam or diflufenzopyr;

E6 carotenoid biosynthesis inhibitors, for example
beflubutamid, benzofenap, clomazon (dimethazon), diflufenican, fluorochloridon, fluridon, pyrasulfutol, pyrazolynate, pyrazoxyfen, isoxaflutol, isoxachlortol, mesotrione, sulcotrione (chlormesulon), tefuryltrione, tembotrione, ketospiradox, flurtamon, norflurazon, amitrol, picolinafen, benzobicyclon or CAS-No.: 352010-68-5;

E7 enolpyruvyl-shikimate 3-phosphate synthase inhibitors (EPSPS), for example
glyphosate or sulfosate;

E8 glutamine synthetase inhibitors, for example
bilanafos (bialaphos) or glufosinate-ammonium;

E9 lipid biosynthesis inhibitors, for example
anilides such as anilofos;
chloroacetanilides such as dimethenamid, S-dimethenamid, acetochior, alachlor, butachlor, butenachlor, diethatyl-ethyl, dimethachlor, metazachlor, metolachlor, S-metolachlor, pethoxamid, pretilachlor, propachlor, prynachlor, terbuchlor, thenylchlor or xylachlor;
acetamides such as diphenamid, napropamide and naproanilide;
oxyacetamides such as flufenacet or mefenacet;
thiocarbamates such as butylate, cycloate, di-allate, dimepiperate, EPIC, esprocarb, molinate, orbencarb, pebulat, prosulfocarb, thiobencarb (benthiocarb), thiocarbazil, tri-allate or vernolate; or
tetrazolinones such as fentrazamide;
isoxazoline such as pyroxasulfone (KIH-485);
benfuresate, ethofumesate, cafenstrole or perfluidon;

E10 mitosis inhibitors, for example
carbamates such as asulam, carbetamid, chlorpropham, pronamid (propyzamid), propham;
dinitroanilines such as benefin (=benfluralin), butralin, dinitramin, ethalfluralin, fluchloralin, oryzalin, pendimethalin, prodiamin or trifluralin;
pyridines such as dithiopyr or thiazopyr; or
butamifos, chlorthal-dimethyl (DCPA) or maleic hydrazide;

E11 protoporphyrinogen-IX oxidase inhibitors, for example
diphenyl ethers such as acifluorfen, acifluorfen-sodium, aclonifen, bifenox, chlornitrofen (CNP), ethoxyfen, fluorodifen, fluoroglycofen-ethyl, fomesafen, furyloxyfen, lactofen, nitrofen, nitrofluorfen or oxyfluorfen;
oxadiazoles such as oxadiargyl or oxadiazone;
cyclic imides such as azafenidin, butafenacil, carfentrazone-ethyl, cinidon-ethyl, flumiclorac-pentyl, flumioxazin, flumipropyne, flupropacil, fluthiacet-methyl, sulfentrazone or thidiazimin;
pyrazoles such as pyraflufen-ethyl (ET-751), fluazolate (JV 485) or nipyraclofen;
pyridazinones such as flufenpyr-ethyl; or
triazolones such as benzcarbazone;

E12 photosynthesis inhibitors, for example
propanil, pyridate or pyridafol;
benzothiadiazinone such as bentazone;
dinitrophenols such as bromofenoxim, dinoseb, dinoseb-acetate, dinoterb or DNOC;
dipyridylenes such as cyperquat-chloride, difenzoquat-methylsulfate, diquat or paraquat-dichloride;
ureas such as chlorbromuron, chlortoluron, difenoxuron, dimefuron, diuron, ethidimuron, fenuron, fluometuron, isoproturon, isouron, linuron, methabenzthiazuron, methazol, metobenzuron, metoxuron, monofinuron, neburon, siduron or tebuthiuron;
phenols such as bromoxynil or loxynil;
chloridazone;
triazines such as ametryne, atrazine, cyanazine, desmetryne, dimethamethryne, hexazinon, prometon, prometryne, propazine, simazine, simetryne, terbumeton, terbutryne, terbutylazine or trietazine;
triazinones such as metamitron or metribuzin;
uracils such as bromacil, lenacil or terbacil; or
biscarbamates such as desmedipham or phenmedipham;
triazolinones such as amicarbazone;

E13 synergists, for example
oxiranes such as tridiphan;

E14 growth regulators, for example
aryloxyalkanoic acids such as, for example, 2,4-DB, clomeprop, dichlorprop, dichlorprop-P (2,4-DP-P), MCPA, MCPB, mecoprop, mecoprop-P;
benzoic acids such as chloramben or dicamba; or
quinolinecarboxylic acids such as quinclorac or quinmerac;

E15 cell wall synthesis inhibitors, for example
isoxaben, flupoxam or dichlobenil;

E16 various other herbicides, for example
dichiorpropionic acids such as dalapon;
phenyl acetic acids such as chiorfenac (fenac);
arylaminopropionic acids such as flamprop-methyl or flamprop-isopropyl; or
aziprotryne, barbane, bensulid, benzthiazuron, benzofluor, buminafos, buthidazol, buturon, chiorbufam, chlorfenprop-methyl, chlorxuron, cinmethylin, cumyluron, cyciuron, cyprazin, cyprazole, dibenzyluron, dipropetryne, dymrone, egfinazine-ethyl, endothall, ethiozine, fluorbentranil, isocarbamid, isopropalin, karbutilate, mefluidid, monuron, napropamid, napropanilid, nitralin, oxaciclomefon, phenisopham, piperophos, procyazin, profluralin, pyributicarb, secbumeton, sulf-allate (CDEC), terbucarb, triaziflam, triazofenamid or trimeturon;

Assigning the active substances to the respective mechanisms of action is based on current knowledge. In the event that a plurality of mechanisms of action apply to an active substance, this substance was only assigned to one mode of action.

In accordance with one embodiment, especially preferred component e) of the composition according to the invention are triazines, among which in particular atrazine or tertbutylazine.

In a further embodiment, a preferred component e) of the composition according to the invention is the combination of triazines and chloroacetanilides, in particular of atrazine and dimethenamid or S-dimethenamid.

Another extraordinarily preferred component e) of the composition according to the invention is the combination of triazines and sulfonylureas, in particular of atrazine and nicosulfuron.

The weight ratio of component a) and any further herbicide which is used as component e) in the composition according to the invention is preferably in the range of 1:0.001 to 1:1000, preferably from 1:0.01 to 1:200, especially preferably from 1:0.01 to 1:100.

The mixture according to the invention can furthermore comprise a safener, as component f).

Suitable safeners f) are substances such as benoxacor, cloquintocet, cyometrinil, dichlormid, dicycionon, dietholate, fenchchlorazol, fenclorim, flurazol, fluxofenim, furilazol, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro-[4.5]decane (AD-67, MON 4660), N-[[4-(cyclopropylamino)carbonyl]phenyl]sulfonyl]-2-methoxybenzamide II (CAS No. 221667-31-8, cyprosulfamid) and oxabetrinil.

In one embodiment of the invention, the following safeners are especially preferred: benoxacor, cloquintocet, dichlormid, fenchchlorazol, fenclorim, fluxofenim, furilazol, isoxadifen, mefenpyr, AD-67 and oxabetrinil.

The herbicides e) from groups E1 to E16 and the components f) can, if appropriate, also be present in the form of their environmentally tolerated salts, esters and amides. In general, suitable salts are the salts of those cations, or the acid addition salts of those acids, whose cations or anions, respectively, do not adversely affect the herbicidal activity of the active substances.

Suitable cations are, in particular, ions of the alkali metals, preferably lithium, sodium and potassium, of the alkali earth metals, preferably calcium and magnesium, and of the transition metals, preferably manganese, copper, zinc and iron, and ammonium, in which case it may be possible, if desired, for one to four hydrogen atoms to be replaced by C₁-C₄-alkyl, hydroxy-C₁-C₄-alkyl, C₁-C₄-alkoxy-C1-C₄-alkyl, hydroxy-C₁-C₄-alkoxy-C₁-C₄-alkyl, phenyl or benzyl, preferably ammonium, isopropylammonium, dimethylammonium, diisopropylammonium, tetramethylammonium, tetrabutylammonium, 2-(2-hydroxyeth-1-oxy)eth-1-ylammonium, di(2-hydroxyeth-1-yl)ammonium, trimethylbenzylammonium ions, furthermore phosphonium ions, sulfonium ions, preferably tri(C₁-C₄-alkyl)sulfonium, and sulfoxonium ions, preferably tri(C₁-C₄-alkyl)sulfoxonium.

Anions of suitable acid addition salts are, namely, chloride, bromide, fluoride, hydrogen sulfate, sulfate, dihydrogen phosphate, hydrogen phosphate, nitrate, hydrogen carbonate, carbonate, hexafluorosilicate, hexafluorophosphate, benzoate, and the anions of C₁-C₄-alkanoic acids, preferably formate, acetate, propionate and butyrate.

Suitable esters are alkyl, alkoxyalkyl, allyl, propargyl and oxetan-3-yl esters, especially C₁-C₁₀-esters, for example methyl, ethyl, propyl, isopropyl, butyl, isobutyl, pentyl, mexyl(≡1 -methylhexyl) or isoctyl (≡2-ethylhexyl) esters, C₁-C₄-alkoxy ethyl esters, for example methoxyethyl, ethoxyethyl or butoxyethyl esters, allyl esters, proparygl esters and oxetan-3-yl esters.

Suitable amides are unsubstituted amides, alkylamides and dialkylamides and anilides, preferably C₁-C₄-alkylamides, for example methyl- or ethylamide, amides, for example dimethyl- or diethylamide, or anilides, preferably the unsubstituted anilide, or 2-chloroanilide.

The components e) and f) and/or their salts, esters, amides and hydrates may, if appropriate, be present in the composition according to the invention as the pure enantiomers and also as racemates or diastereomer mixtures, or as tautomers.

The components a) to e) can be used individually, partially premixed or fully pre-mixed with one another, or as component of a combined product according to the invention, for preparing the composition according to the invention.

The user, for example the farmer, will apply the composition according to the invention, or the ready-to-use spray mixture, usually for use from a predosage device, a knapsack sprayer, a spray tank or a spray plane.

In accordance with one embodiment of the invention, the composition according to the invention is brought to the desired use concentration with the aid of water and/or buffer, with further adjuvants and additives being added if appropriate.

In accordance with another embodiment, the user himself can mix the individual components of the composition according to the invention in the spray tank, bring them to the desired use concentration with the aid of water and/or buffer and, if appropriate, add further adjuvants and additives (tank mix method).

In a further embodiment, the user can mix both individual components of the composition according to invention or else partially premixed components, for example a) and c) or a) and e), in the spray tank, bring the mixture to the desired use concentration with the aid of water (b) and/or buffer and, if appropriate, add further adjuvants and additives (tank mix method).

In one embodiment according to the invention, the component a) can be used as unformulated active substance for the preparation of the composition according to the invention. In accordance with another embodiment according to the invention, the component a) is, for example, in the form of an active substance formulated together with adjuvants. In accordance with a further embodiment, the component a) is prepared in situ by reacting the compound of the formula I-H

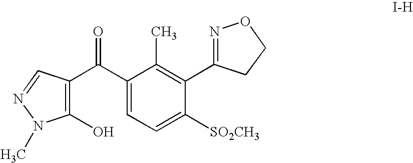

with a suitable base, such as, for example, NaOH, KOH or NH₄OH.

The components e) and/or if appropriate f) of the composition according to the invention can also be used formulated together with adjuvants in order to prepare said composition.

The composition according to the invention can be used for example in the form of directly sprayable aqueous solutions or dispersions, also highly concentrated aqueous, oily or other suspensions or emulsions, by trickling, spraying, fogging or pouring. The use forms depend on the intended purposes; in any case, they should ensure the finest possible distribution of the herbicidal mixture according to the invention.

Aqueous use forms of the composition according to the invention can be prepared from emulsion concentrates, suspensions, pastes, wettable powders or water-dispersible granules. To prepare emulsions, pastes or oil dispersions, the components as such or dissolved in an oil or solvent, can be homogenized in water by means of wetter, adhesive, dispersant or emulsifier. However, it is also possible to prepare concentrates consisting of the components, wetter, adhesive, dispersant or emulsifier and, if appropriate, solvent or oil, and such concentrates are suitable for dilution with water.

Powders, materials for spreading and dusts can be prepared, for example by mixing or jointly grinding the component a), if appropriate fertilizer c), if appropriate other herbicides e) and, if appropriate, safener f) together with a solid carrier. Granules, for example coated granules, impregnated granules and homogenous granules, can be prepared by binding the component a), if appropriate fertilizer c), if appropriate other herbicides e) and, if appropriate, safener f) to solid carriers.

In general, the following are suitable examples of adjuvants and additives for formulating the individual components of the composition according to the invention itself, or for preparing the ready-to-use spray mixture:

Inert additives or carriers such as mineral oil fractions of medium to high boiling point, such as kerosene or diesel oil, furthermore coal-tar oils and oils of vegetable or animal origin, aliphatic, cyclic and aromatic hydrocarbons, for example paraffin, tetrahydro-naphthalene, alkylated naphthalenes or their derivatives, alkylated benzenes or their derivatives, alcohols such as methanol, ethanol, propanol, butanol, cyclohexanol, ketones such as cyclohexanone or strongly polar solvents, for example amines such as N-methylpyrrolidone, or water.

Suitable adjuvants are, for example, the compounds described as component d).

Buffer or buffer solutions are solutions which hardly change their pH value when strong acids or bases are added. Buffer solutions usually consist of a weak acid, for example acetic acid, and one of its salts, for example sodium acetate.

To improve the processing, further adjuvants and additives may be added. In this context, the following components are found to be useful: further solvents, antifoams, buffer substances, thickeners, spreading agents, agents which promote compatibility, liquid and solid carriers, surfactants.

Solid carriers are, for example, mineral earths, such as silicic acids, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers, such as ammonium sulfate, ammonium phosphate, ammonium nitrate, ureas and products of vegetable origin, such as cereal meal, tree bark meal, wood meal and nutshell meal, cellulose powder or other solid carriers.

Suitable surfactants are the alkali metal, alkaline earth metal and ammonium salts of aromatic sulfonic acids, for example lignin-, phenol-, naphthalene- and dibutyl-naphthalenesulfonic acid, and also of fatty acids, alkyl- and alkylarylsulfonates, alkyl sulfates, lauryl ether sulfates and fatty alcohol sulfates, and also salts of sulfated hexa-, hepta- and octadecanols and also of fatty alcohol glycol ethers, condensates of sulfonated naphthalene and its derivatives with formaldehyde, condensates of naphthalene or of naphthalenesulfonic acid with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors or methylcellulose.

Examples of these are described in Farm Chemicals Handbook 1997; Meister Publishing 1997 p. CI0 “adjuvant” or 1998 Weed Control Manual p. 86.

The composition according to the invention is suitable as a herbicide. It effects very good control of vegetation on non-crop areas, especially at high application rates. In crops such as wheat, rice, corn, soybeans and cotton, it acts against broad-leaved weeds and grass weeds, without causing any significant damage to the crop plants. This effect is mainly observed at low application rates.

Grass weeds which can be controlled with the composition according to the invention are, for example, Aegilops cylindrica, Alopecurus myosuroides, Agrostis stolonifera, Agropyron repens, Apera Spica-venti, Avena fatua, Avena ludoviciana, Avena sterilis, Brachiaria brizantha, Brachiaria plantaginea, Brachiaria platyphylla, Brachiaria decumbens, Bromus arvensis, Bromus inermis, Bromus mollis, Bromus secalinus, Bromus sterilis, Bromus tectorum, Cenchrus echinatus, Cenchrus incertus, Cynodon dactylon, Dactyloctenium aegyptium, Digitaria adscendens, Digitaria ciliaris, Digitaria horizontalis, Digitaris ischaemum, Digitaria sanguinalis, Echinochloa colonum, Echinochloa Echinochloa crus-pavonis, Echinochloa spp., Eleusine indica, Eriochloa gracilis, Eriochloa villosa, Imperata cylindria, Ischaemum rugosum, Leptochloa chinensis, Leptochloa fascicularis, Leptochloa filiformis, Lolium multiflorum, Lolium perenne, Lolium rigidum, Lolium temulentum, Panicum capillare, Panicum dichotomiflorum, Panicum maximum, Panicum miliaceum, Panicum repens, Panicum texanum, Phalaris brachystachys, Phalaris canariensis, Phalaris minor, Poa annua, Poa trivialis, Roettboellia exaltata, Setaria faberi, Setaria Italica, Setaria lutescens (=glauca), Setaria verticilliata, Setaria viridis, Setaria spec., Sorghum bicolor, Sorghum halepense.

It is preferred to use the composition according to the invention to control Avena fatua, Avena ludoviciana, Avena sterilis, Brachiaria brizantha, Brachiaria plantaginea, Brachiaria platyphylla, Brachiaria decumbens, Cenchrus echinatus, Cenchrus incertus, Cynodon dactylon, Dactyloctenium aegyptium, Digitaria adscendens, Digitaria ciliaris, Digitaria horizontalis, Digitaris ischaemum, Digitaria sanguinalis, Echinochloa colonum, Echinochloa crus-galli, Echinochloa crus-pavonis, Echinochloa spp., Eleusine indica, Eriochloa gracilis, Eriochloa villosa, Imperata cylindria, Ischaemum rugosum, Leptochloa chinensis, Leptochloa fascicularis, Leptochloa filiformis, Panicum capillare, Panicum dichotomiflorum, Panicum maximum, Panicum miliaceum, Panicum repens, Panicum texanum, Phalaris brachystachys, Phalaris canariensis, Phalaris minor, Roettboellia exaltata, Setaria faberi, Setaria Italica, Setaria lutescens (=glauca), Setaria verticilliata, Setaria viridis, Setaria spec., Sorghum bicolor and Sorghum halepense.

It is particularly preferred to use the composition according to the invention to control Brachiaria brizantha, Brachiaria plantaginea, Brachiaria platyphylla, Brachiaria decumbens, Cenchrus echinatus, Cenchrus incertus, Digitaria adscendens, Digitaria ciliaris, Digitaria horizontalis, Digitaris ischaemum, Digitaria sanguinalis, Echinochloa colonum, Echinochloa crus-galli, Echinochloa crus-pavonis, Echinochloa spp., Eleusine indica, Eriochloa gracilis, Eriochloa villosa, Panicum capillare, Panicum dichotomifiorum, Panicum maximum, Panicum miliaceum, Panicum repens, Panicum texanum, Setaria faberi, Setaria Italica, Setaria lutescens (=glauca), Setaria verticilliata Setaria viridis, Setaria spec. and Sorghum bicolor.

The composition according to the invention acts against weeds such as Abutilon theophrasti, Acanthospermurn australe, Acanthospermurn hispidum, Aeschynomene indica, Aeschynomene virginica, Aeschynomene sensitiva, Alternanthera philoxeroides, Amaranthus retroflexus, Amaranthus rudis, Amaranthus tuberculatus, Amaranthus spp., Ambrosia artemisifolia, Ambrosia trifida, Anagallis arvensis, Anoda cristata, Anthemis arvensis, Aphanes arvensis, Atriplex patula, Atriplex hastata, Bidens pilosa, Capsella bursa-pastoris, Cassia obtusifolia, Cassia occidentalis, Cassia tora, Centaurea cyanus, Chenopodium album, Chenopodium hybridum, Chenopodium spp., Cirsium arvense, Convolvulus arvensis, Conyza canadensis, Datura stramonium, Daucus carota, Desmodium tortuosum, Euphorbia heterophylla, Euphorbia hirta, Galeopsis tetrahit, Galinsoga cilliata, Galinsoga parviflora, Helianthus annuus, Ipomoea acuminata, Ipomoea hederacea, Ipomoea lacunosa, Ipomonea purpurea, Ipomoea ssp., Kochia scoparia, Lamium ampiexicaule, Lamium purpureum, Malva neglects, Malva sylvestris, Matricaria chamomilla, Matricaria inodora, Mercurialis annua, Papaver rhoeas, Polygonum aviculare, Polygonum convolvulus, Polygonum lapathifolium, Polygonum persicaria, Portulaca oleracea, Richardia brasiliensis, Rumex spp., Salsola kali, Sesbania exaltata, Sida rhombifolia, Sida spinosa, Sinapis arvensis, Solanum nigrum, Solanum pthycanthum, Solanum spp., Sonchus arvensis, Sonchus oleraceae, Stellaria media, Tagetes minuta, Taraxacum officinale, Thlaspi arvense, Veronica hederaefolia, Veronica persica, Viola arvensis, Xanthium strumarium, Xanthium spinosum.

It is preferred to use the composition according to the invention to control Abutilon theophrasti, Aeschynomene indica, Aeschynomene virginica, Aeschynomene sensitiva, Alternanthera philoxeroides, Amaranthus retroflexus, Amaranthus rudis, Amaranthus tuberculatus, Amaranthus spp., Ambrosia artemisifolia, Ambrosia trifida, Anoda cristata, Atriplex patula, Atriplex hastata, Bidens pilosa, Cassia obtusifolia, Cassia occidentalis, Cassia tora, Chenopodium album, Chenopodium hybridum, Chenopodium spp., Conyza canadensis, Datura stramonium, Daucus carota, Galeopsis tetrahit, Galinsoga cilliata, Galinsoga parviflora, Helianthus annuus, Ipomoea acuminata, Ipomoea hederacea, Ipomoea lacunosa, Ipomonea purpurea, Ipomoea ssp., Kochia scoparia, Malva neglecta, Mercurialis annus, Polygonum convolvulus, Polygonum lapathifolium, Polygonum persicaria, Portulaca oleracea, Richardia brasiliensis, Rumex spp., Salsola kali, Sesbania exaltata, Sida rhombifolia, Sida spinosa, Solanum nigrum, Solarium pthycanthum, Solanum spp., Sonchus arvensis, Sonchus oleraceae, Tagetes minuta, Xanthium strumarium and Xanthium spinosum.

It is especially preferred to use the composition according to the invention to control Abutilon theophrasti, Amaranthus retroflexus, Amaranthus rudis, Amaranthus tuberculatus, Amaranthus spp., Ambrosia artemisifolia, Ambrosia trifida, Anode cristata, Atriplex patula, Atriplex hastata, Bidens pilosa, Chenopodium album, Chenopodium hybridum, Chenopodium spp., Conyza canadensis, Datura stramonium, Galinsoga cilliata, Galinsoga parviflora, Helianthus annuus, Ipomoea acuminate, Ipomoea hederacea, Ipomoea lacunosa, Ipomonea purpurea, Ipomoea ssp., Kochia scoparia, Polygonum convolvulus, Polygonum lapathifolium, Polygonum persicaria, Portulaca oleracea, Richardia brasiliensis, Salsola kali, Side spinosa, Solanum nigrum, Solanum pthycanthum, Solanum spp., Xanthium strumarium and Xanthium spinosum.

Depending on the application method in question, the herbicidal composition can be used in a further number of crop plants for eliminating undesired plants. Suitable are, for example, the following crops:

Allium cepa, Ananas comosus, Arachis hypogaea, Asparagus officinalis, Avena sativa, Beta vulgaris spec. altissima, Beta vulgaris spec. rape, Brassica napus var. napus, Brassica napus var. napobrassica, Brassica nigra, Brassica oleracea, Brassica rapa var. silvestris, Camellia sinensis, Carthamus tinctorius, Carya illinoinensis, Citrus limon, Citrus sinensis, Coffea arabica (Coffea canephora, Coffee liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticale, Triticum aestivum, Triticum durum, Vida faba, Vitis vinifera and Zea mays.

In addition, the composition according to the invention can also be used in crops which are tolerant to the action of herbicides owing to classic breeding or else as a result of genetic engineering.

Application of the composition according to the invention can be by the pre-emergence or by the post-emergence method. If the composition according to the invention is less well tolerated by certain crop plants, application techniques may be used in which the composition according to the invention is sprayed, with the aid of the spraying equipment, in such a way that as far as possible it does not come into contact with the leaves of the sensitive crop plants, while the herbicidal composition reaches the leaves of unwanted plants growing underneath, or the bare soil surface (post-directed, lay-by).

It may be beneficial to apply the composition according to the invention alone or jointly in combination with other herbicides or else in the form of a mixture with further crop protection agents, for example with agents for controlling pests or phytopathogenic fungi or bacteria. Also of interest is the miscibility with mineral salt solutions, which are employed for treating nutritional and trace element deficiencies.

Compositions According to the Invention

1) Water-Soluble Concentrate of the Compound of the Formula I

For example 100 g of the active substance 4-[2-methyl-3-(4,5-dihydroisoxazol-3-yl)-4-methylsulfonylbenzoyl]-1-methyl-5-hydroxy-1H-pyrazole (I-H; 99% technical grade) are dispersed in water (b), for example in approx. 300 ml. The active substance is neutralized with a dilute base, for example KOH, and the composition is brought to pH 8.5.

Thereafter, if appropriate, component d), for example 500 g of AG 6202, is stirred in. After the mixture has been homogenized, the pH is checked again and, if necessary, corrected. The product is then made up to 1 liter.

The following compositions according to the invention were prepared in accordance with the above protocol:
1.1 240 g/l 2-(2-hydroxyeth-1-oxy)eth-1-ylammonium salt
1.2 240 g/l sodium salt
1.3 37.5 g/l ammonium salt+fertilizer c) 500 g/l Ensol 27% N+d) 500 g/l Lutensol ON 70
1.4 50 g/l ammonium salt+fertilizer c) 500 g/l Ensol 27% N+d) 500 g/l Lutensol ON 70
1.5 50 g/l sodium salt+d) 500 g/l;AG-6202
1.6 50 g/l sodium salt+d) 500 g/l AG-6206
1.7 50 g/l sodium salt+d) 500 g/l Emulan HE 50
1.8 50 g/l sodium salt+d) 500 g/l Lutensol ON 70
1.9 50 g/l sodium salt+d) 500 g/l Lutensol XP 70
1.10 50 g/l sodium salt+d) 500 g/l MeO-(EO)₁₁-NH₂
1.11 50 g/l sodium salt+d) 500 g/l Pluriol A 11 RE
1.12 50 g/l sodium salt+d) 500 g/l (aziridin)₄₀-(EO)₂₈₀
1.13 50 g/l sodium salt+d) 500 g/l Berol LFG 61
1.14 50 g/l sodium salt+d) 500 g/l Genapol B
1.15 37.5 g/l sodium salt+d) 500 g/l AG-6202
1.16 37.5 g/l sodium salt+d) 500 g/l Emulan HE 50
1.17 37.5 g/l sodium salt+d) 500 g/l Lutensol ON 70
1.18 37.5 g/l sodium salt+d) 500 g/l Lutensol XP 70

Lutensol ON 70: iso-C₁₀-oxo alcohol (EO)₇-H (BASF)

AG-6202: alkyl glycoside (Akzo Nobel)

AG-6206: alkyl glycoside (Akzo-Nobel)

Emulan HE 50: ethylene glycol monohexyl ether (BASF)

Berol LFG 61: mixture of alkyl glycoside and alcohol ethoxylate (AkzoNobel)

Lutensol XP 70: alkyl polyethylene glycol ether (BASF)

Pluriol A 11 RE: alkoxylates based on allyl alcohol or butynediol (BASF)

Genapol B: ethylenediamine EO-PO block copolymer (Clariant)

Component a), the compounds of the formula I in the composition according to the invention, was prepared in each case in situ from the compound 4-[2-methyl-3-(4,5-dihydroisoxazol-3-yl)-4-methylsulfonylbenzoyl]-1-methyl-5-hydroxy-1H-pyrazole (I-H) by adding alkali; the concentration, which is given in [g/l], refers to the free active substance employed.

### USE EXAMPLE

The herbicidal activity of the composition according to the invention was demonstrated by greenhouse experiments:

The culture containers used were plastic pots containing, as substrate, loamy sand with approximately 3.0% humus. The seeds of the test plants were sown separately, according to species.

For the pre-emergence treatment, the herbicidal composition was applied directly after sowing by means of finely distributing nozzles. The containers were irrigated slightly to promote germination and growth and then covered with translucent plastic hoods until the plants had rooted. This cover brings about a uniform germination of the test plants, unless this is adversely effected by the herbicidal composition.

For the post-emergence treatment, the test plants were first grown to a plant height of 3 to 15 cm, depending on the growth habit, and only then treated with the herbicidal composition. The test plants were grown either by sowing them directly into the test containers or by sowing them into seedling trays and subsequently transplanting the test plants into the test containers a few days before the treatment.

Depending on the species, the plants were kept at temperatures of from 10-25° C. or 20-35° C. The test period extended over 2 to 4 weeks. During this time, the plants were tended, and their response to the individual treatments was evaluated.

The activity of the herbicidal composition on the test plants was evaluated by direct comparison with untreated test plants, using a percentage scale (0 to 100%). In this context 100% means no emergence of the plants, or complete destruction of at least the aerial parts, and 0% means no damage or normal growth.

The composition according to the invention comprising the compound of the formula I dissolved in water (SL formulation) was studied for its herbicidal efficacy post-emergence in comparison with a composition comprising the compound of the formula I-H (free acid) in suspended form (SC formulation; comparative example).

TABLE 1
Comparison of the composition according to the invention
(50 g/l compound of the formula I, Na salt) with a corresponding
SC formulation (50 g/l compound of the formula I-H, free acid);
efficacy [%]

| | | SC |
|---|---|---|
| Composition, | SL | (comparative example) |
| application rate of a.s. | 25 g/ha | 25 g/ha |
| Zea mays | 0 | 0 |
| Brachiaria plantaginea | 90 | 80 |
| Panicum dichotomiflorum | 100 | 95 |
| Eriochloa villosa | 85 | 80 |
| Panicum miliaceum | 98 | 90 |
| Setaria viridis | 98 | 95 |
| Abutilon theophrasti | 90 | 85 |

TABLE 2
Comparison of the composition according to the invention
(50 g/l compound of the formula I, Na salt) with a corresponding
SC formulation (50 g/l compound of the formula I-H, free acid),
in each case as a tank mix with SUN-IT II (methylated or ethylated
vegetable oil) which was present in the tank mix in a final
concentration of 0.625% by volume; efficacy [%]

| Composition, | SL | SC (comparative example) |
|---|---|---|
| application rate of a.s. | 25 g/ha + SUN-IT II | 25 g/ha + SUN-IT II |
| Zea mays | 0 | 0 |
| Digitaria sanguinalis | 100 | 95 |
| Panicum maximum | 98 | 95 |

TABLE 3
Comparison of the composition 1.8 according to the invention
(50 g/l compound of the formula I, Na salt + 500 g/l Lutensol ON70)
with a corresponding SC formulation (50 g/l compound of the
formula I-H, free acid + 400 g/l Lutensol ON70); efficacy [%]

| Composition, | SL | SC (comparative example) |
|---|---|---|
| application rate of a.s. | 12.5 g/ha | 12.5 g/ha |
| Zea mays | 0 | 0 |
| Echinochloa crus-galli | 85 | 80 |
| Setaria faberi | 95 | 90 |
| Setaria lutescens | 80 | 70 |
| Setaria viridis | 85 | 80 |
| Amaranthus retroflexus | 98 | 95 |
| Xanthium strumarium | 95 | 90 |

The examples demonstrate the improved herbicidal activity of the composition according to the invention in comparison with corresponding SC formulations.

1.-12. (canceled)

13. A herbicidally active composition comprising
a) a compound of the formula I, 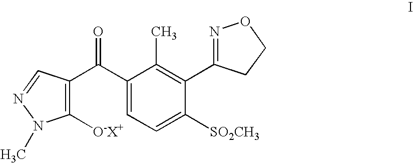
where X is a monovalent cation, and
b) water, and
where the compound of the formula I is in water-dissolved form.

14. The composition according to claim 13, wherein the monovalent cation in the compound of the formula I is an alkali metal ion selected from the group consisting of Li⁺, Na⁺ and K⁺.

15. The composition according to claim 13, wherein the monovalent cation in the compound of the formula I is NR¹R²R³R⁴⁺, where R¹, R², R³, R⁴ independently of one another are selected from the group consisting of hydrogen, C₁-C₄-alkyl and 2-(2-hydroxyeth-1-oxy)eth-1-ylammonium.

16. The composition according to claim 13, wherein the composition further comprises at least one nitrogen-comprising fertilizer.

17. The composition according to claim 13, wherein said fertilizer is selected from the group consisting of aqueous ammonia solution, ammonium salts, urea, thiourea and their mixtures.

18. The composition according to claim 15, wherein the composition further comprises at least one nitrogen-comprising fertilizer.

19. The composition according to claim 18, wherein said fertilizer is selected from the group consisting of aqueous ammonia solution, ammonium salts, urea, thiourea and their mixtures.

20. The composition according to claim 13, which further comprises at least one adjuvant.

21. The composition according to claim 13, which further comprises at least one further herbicide.

22. The composition according to claim 19, which further comprises at least one adjuvant.

23. The composition according to claim 19, which further comprises at least one further herbicide.

24. The composition according to claim 22, which further comprises at least one further herbicide.

25. The composition according to claim 13, wherein the compound of the formula I is present in a concentration of from 0.005 [g/l] to 500 [g/l].

26. The composition according to claim 16, wherein the compound of the formula I and the nitrogen-comprising fertilizer are present in a weight ratio of from 1:2.5 to 1:10000.

27. The composition according to claim 20, wherein the compound of the formula I and the adjuvant are present in a weight ratio of from 1:2.5 to 1:5000.

28. The composition according to claim 21, wherein the compound of the formula I and the further herbicide are present in a weight ratio of from 1:0.001 to 1:1000.

29. The composition according to claim 24, wherein the compound of the formula I is present in a concentration of from 0.005 [g/l] to 500 [g/l].

30. The composition according to claim 25, wherein the compound of the formula I and the nitrogen-comprising fertilizer are present in a weight ratio of from I :2.5 to 1:10000, the compound of the formula I and the adjuvant are present in a weight ratio of from 1:2.5 to 1:5000 and the compound of the formula I and the further herbicide are present in a weight ratio of from 1:0.001 to 1:1000.

31. A method of controlling undesired vegetation, which comprises allowing a composition according to claim 13 to act on the plants and/or their environment.
